(19) United States
(12) Patent Application Publication
(10) Pub. No.: US 2025/0368919 A1
(43) Pub. Date: Dec. 4, 2025

(54) A NOVEL PROCESS FOR REFINING A FEEDSTOCK

(71) Applicant: Neste Oyj, Espoo (FI)

(72) Inventors: Marcelo USSEGLIO, Porvoo (FI); Sami ALAKURTTI, Porvoo (FI)

(73) Assignee: Neste Oyj, Espoo (FI)

(21) Appl. No.: 18/876,469

(22) PCT Filed: Jun. 29, 2023
(86) PCT No.: PCT/FI2023/050407

§ 371 Date: Dec. 18, 2024

(30) Foreign Application Priority Data
Jun. 30, 2022 (FI) 20225613

(51) Int. Cl. C11B 13/00; C02F 11/00; C11B 3/00; C11B 3/04; C11B 3/10

(52) U.S. Cl. CPC C11B 13/00; C02F 11/00; C11B 3/001; C11B 3/008; C11B 3/04; C11B 3/10

(57) ABSTRACT

Present disclosure relates to a novel and effective process for refining or purifying of a feedstock.

Present invention relates to an efficient, cost effective and novel method to refine or purify a feedstock comprising components generally considered difficult to refine or purify into useful components in e.g. the fuel industry or as a starting material for any type of fuel or fine chemical. One example of a feedstock to which present invention relates is palm oil mill effluent (POME) oil and the refining thereof. Such feedstock has proven to be challenging in processing directly in e.g. bleaching, due to the type of impurities found therein. Impurity removal (metals and phosphorous compounds) but also filterability characteristics during bleaching post-filtration are in general very poor. Present invention overcomes these difficulties.

### BACKGROUND OF THE INVENTION

As mentioned above, feedstocks such as e.g. palm oil mill effluent (POME) oil is a challenging feedstock to process directly in bleaching, owing to the type of impurities found in POME oil. Impurity removal (metals and phosphorous compounds) but also filterability characteristics during bleaching post-filtration are very poor. Currently crude POME oil cannot be pre-processed by any method allowing it to be fed to PTU (Pre-Treatment Unit), except by evaporation (distillation to obtain POME-FAD/Palm Oil Mill Effluent-Fatty Acid Distillate) which is very expensive and making this type of feedstock less attractive from a commercial point of view.

Acid degumming, which may be also used to purify POME oil, and different types of variations have been used in the edible vegetable oil industry for many decades to remove the residual phospholipids (80-200 ppm as phosphorus) and metals contents from water degummed oil using a citric acid aqueous solution and process water.

The main drawback in the acid degumming is that the oil loss during centrifugation is high, due to a given entrained oil that is carried over to the water phase because of emulsion effects or separation efficiency and the heavy-water phase that is generated which needs expensive wastewater treatment. Moreover, a washing stage is usually used to further increase removal of residual metals and P, in which 2-3% of process water is added to the oil and then separated in a second centrifugal separator is also needed to improve the phosphorus removal. Moreover, the acid degumming process is sensitive to the amount of solids in the feedstock and it can handle only feedstocks having low amounts of solids. In addition, very low quality (very high COD values) wastewater is produced, which disposal is problematic and costly.

### SUMMARY OF THE INVENTION

Present invention overcomes the above drawbacks and provides for a cost efficient, large-scale process to refine or purify certain feedstocks to low, single digit ppm, level of metals and phosphorous impurities. Inherently, this entail low loss of oil. The process also enables recycling of the process water back into the process, thereby minimizing waste water treatment and water consumption. Moreover, it has been found that the filterability in the bleaching of the resulting pre-processed product is improved (filterability resistance is reduced) as a result of the process. This greatly enhances the industrial processing in large scale of feedstocks mentioned herein.

Consequently, present invention provides for methods or products displaying one or more of,
An improved removal of one or more of nitrogen, phosphorous and metal containing compounds from a feedstock,
A reduced filterability resistance when processing the feedstock,
Minimisation of consumption of process water by re-cycling such water back into the process,
Reduction of wastewater which has both economical and environmental benefits,
Reduced oil loss, i.e. the yield of the obtained purified feedstock is increased by reducing loss thereof during the processing.

In one aspect, present invention relates to a process or method for refining or purification of a raw material or feedstock.

The process according to the invention may comprise any combination of the steps of:
i) providing a feedstock,
ii) optionally heating the provided feedstock,
iii) treating the provided feedstock with an acid, wherein the acid is capable of forming a precipitate, or salt, or chelate with the impurities present in the feedstock,
iv) treating the acid treated feedstock in iii) with process water wherein the water content of the acid treated feedstock in iv) is adjusted to be in the range of from about 1 wt % to about 6 wt %, preferably from about 1.5 wt % to about 4 wt %, more preferably from about 2 wt % to about 3 wt %, or about 5 wt %,
v) evaporating the water under vacuum from the acid treated feedstock in iv),
vi) optionally, recovering and recycling from step v) the evaporated water to at least partially re-use it as process water in step iv) and/or in step iii),
vii) contacting the chelated or precipitated metals and/or phospholipids from the acid treated feedstock, with a filter aid and/or with an adsorbent,
viii) removing the chelates or precipitates and filter aid and/or adsorbent by filtration, with or without pre-coat, to obtain an acid treated filtered feedstock,
ix) bleaching the acid treated filtered feedstock from step viii.

In one aspect, the process according to the invention results in an acid treated filtered bleached feedstock by said process.

In another aspect, present invention can include step vi), i.e. re-cycling of the evaporated water to at least partially re-use it as process water in step iv) and/or in step iii). Put differently, re-cycling of the evaporated water into the process may be mandatory. The inventors of present invention have found that the recycled process water offers an equally good result as using fresh water in the process. It has been surprisingly found that the removal of impurities (from the feedstock) using recycled water from water evaporation in acid filtration is as effective as using fresh process water.

In one aspect, the feedstock may comprise or consist of palm oil mill effluent (POME) oil.

In another aspect, the acid is citric acid, phosphoric acid or sulphuric acid.

In yet another aspect, the acid is citric acid.

In one aspect, the concentration of the acid added in step iii), i.e. to treat the provided feedstock, may be in any suitable range, such as e.g. from about 10% to about 95%, such as e.g. about 20% to about 80% such as e.g. about 30% to about 70% such as e.g. about 40% to about 60%, or about 50%. It is to be noted that the percentages in this respect may be either as wt % or as vol %. Non-limiting examples may be that that the acid may be citric acid in a concentration of about 30 wt % to about 50 wt %. Another non-limiting example may be that the acid is phosphoric acid in a concentration of about 75 wt % to about 80 wt %. In yet a further aspect, the acid used may be regarded as concentrated, such as e.g. concentrated sulphuric acid in a concentration of about 96 wt %.

In one aspect, the acid added to treat the provided feedstock may be diluted using addition of water, which may be process water recycled from the process, or alternatively fresh water. The final concentration of the acid in step iii) may be in any range of about 1% to about 90%, such as e.g. about 10% to about 80%, such as e.g. about 20% to about 70%, etc. In another aspect, the dilution is such that the final concentration of the acid in step iii) may be in range of from about 1 wt % to about 6 wt %, preferably from about 1.5 wt % to about 4 wt %, more preferably from about 2 wt % to about 3 wt %, or about 5 wt %,

In one aspect, the acid treated feedstock resulting from step iii) may be treated with process water wherein the water content of the acid treated feedstock in iv) is adjusted to be in the range of from about 1 wt % to about 6 wt %, preferably from about 1.5 wt % to about 4 wt %, more preferably from about 2 wt % to about 3 wt %, or about 5 wt %, or in range of about 1 wt % to about 3 wt %,

In a preferred aspect, at least part of the process water is recycled back into the process.

According to the invention, the feedstock may be heated prior to addition or contacting with the acid.

In one aspect, the feedstock is heated prior to addition or contacting with the acid and then reacted at the same temperature without further need for heating.

According to the invention, the acid may be capable of forming a chelate, a salt or any kind of precipitate or matter that forms a separate phase to the remaining feedstock.

The dosage of the acid is at least 1 stoichiometric equivalent to the impurities (which may be e.g. metal impurities) present in the feedstock.

Present invention also relates to a refined or purified feedstock which may be obtainable by the process according to the invention.

### FIGURES

FIG. 1 illustrates the process according to the invention in form of a flow diagram.

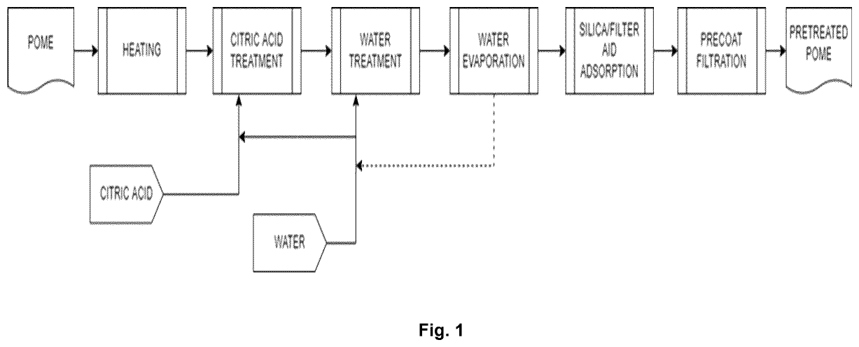

### DEFINITIONS/ABBREVIATIONS

According to the invention the wording or terminology “feedstock” or “raw material” which may be used interchangeably throughout the specification, is intended to mean any type of feedstock of any type of origin such as e.g. plant, animal or microbial origin or may be fossil based or a combination of fossil based feedstock and a feedstock of a plant, animal and/or microbial origin. Such feedstock may also be any type of waste material or by-product resulting from any previous processing. In one embodiment the feedstock comprises at least one of animal fat, animal oil, plant fat, plant oil, fish fat, fish oil, microbial oil, waste fat, waste oil, residue fat, residue oil, a sludge originating from plant oil production, or any combination thereof. In one embodiment the feedstock comprises at least one of acidulated soapstock, poultry fat, dry rendered poultry fat, brown grease, gutter oil, trap grease, DAF (Dissolved Air Flotation) grease, sewage sludge, mixed grease trap waste streams, used cooking oil, tall oil, fraction of tall oil, crude tall oil, tall oil pitch, palm oil effluent sludge, palm oil mill effluent (POME) oil, crude palm oil, palm oil, palm seed oil, palm fatty acid distillate, babassu oil, carinata oil, coconut butter, muscat butter oil, sesame oil, maize oil, poppy seed oil, cottonseed oil, soy oil, laurel seed oil, jatropha oil, palm kernel oil, camelina oil, archaeal oil, bacterial oil, fungal oil, protozoal oil, algal oil, seaweed oil, mustard seed oil, oils from halophiles, soybean oil, technical corn oil, rapeseed oil, colza oil, canola oil, sunflower oil, hemp seed oil, olive oil, linseed oil, mustard oil, peanut oil, castor oil, coconut oil, lard, tallow, train oil, spent bleaching earth oil, lignocellulosic based feeds, or any mixtures thereof.

Specifically, feedstocks according to the invention may comprise palm oil mill effluent (POME) oil, any type of brown grease (BG) such as e.g. gutter oil, trap grease, DAF (Dissolved Air Flotation) grease, sewage sludge and mixed grease trap waste streams, or any mixtures thereof.

The wording or terminology “acid” is intended to mean any type of acid or substance chemically classified as an acid. The acid may be an organic or inorganic acid. The acid may further be a mono-, di-, tri-, or tetra-acid having one or more acid functional groups. Some non-limiting examples may be e.g. citric acid, oxalic acid, malonic acid, succinic acid, glutaric acid, adipic acid, maleic acid, ethylenediaminetetraacetic acid (EDTA), phosphoric acid, sulphuric acid or the likes in any suitable concentration.

The wording or terminology “process water” is intended to mean water introduced to process in acid treatment step iii) and/or in water treatment step iv). Process water may be fresh water, or recycled water from the evaporation step v) or a mixture thereof.

The wording or terminology “filter aid”, which may also be abbreviated as “FA”, is intended to mean any agent consisting of solid particles (as of diatomite) that improves filtering efficiency (as by increasing the permeability of the filter cake) and that is either added to the suspension to be filtered and/or placed on the filter as a layer through which the liquid must pass. Non-limiting examples of filter aids may be e.g. diatomaceous earth (DE), or expanded perlite etc. Other examples of filter aids may be any suitable material that is mineral based, plant based (such as e.g. cellulose based), polymer based (such as e.g. a spun or woven polymer), or any type of composite based material or mixtures of any filter aids. Thus, the filter aid is a product with the main functionality of removing solids present in the feedstock during its processing, and even solids of very small size, and make the filterability of the filtration efficient enough and may be regarded as an agent or compound which mechanically removes solids etc from a feedstock. As is evident throughout the description, filtration may be with or without pre-coat and may vary depending on the type of feedstock.

In one embodiment the filter aid does not have adsorbing properties and/or is not capable of adsorbing one or more components e.g. from the feedstock during any stage of the process according to the invention.

In a further embodiment, the filter aid is not a silica based compound.

In yet a further embodiment, the filter aid may be e.g. based on diatomaceous earth, a plant based filter aid such as e.g. cellulose based, a polymer based filter aid, or may be any type of composite based filter aid.

The wording or terminology “adsorbent” is intended to mean an agent capable of adsorbing one or more components at least partially from the feedstock during any stage of the process according to the invention. Non-limiting examples of adsorbents include such as e.g. activated carbon, silica based compounds such as e.g. silica gel of various types and morphology such as e.g. silica hydrogel. The role of the adsorbent is to remove phosphorous containing compounds and metals from oil phase, and i.e. compounds or agents that may be soluble in the oil phase. Put in a different way, an adsorbent may be a solid substance used to collect solute molecules from a liquid or gas. The adsorbent is capable of exerting the action of adsorption meaning that the adsorbent is capable of extracting a compound by causing said compound to be attached to adsorbents such as e.g. activated carbon or silica gel. Thus, adsorbents may be porous solids which bind liquid or gaseous molecules to their surface, and thus collect solute molecules from a liquid or gas.

The wording or terminology of “silica hydrogel” is intended to mean any synthetic amorphous micronized silica hydrogel with the adsorption properties of phospholipids and cationic metals.

The wording or terminology “body feed” or “body feed filtration” is intended to mean a continuous addition of controlled amounts of filter aid during the operation to maintain a permeable filter cake. If added as a slurry, this may be referred to as a slurry feed.

The wording or terminology “pre-coat filtration” or “pre-coat filter” is intended to mean filters that may be rigid, semi-flexible or flexible screen onto which a filter aid or medium is deposited. During the filtration process the filter medium and the filtrated solids form a filter bed, which works as an additional strainer element to collect much finer contaminants. The “bed” medium may filter by adsorption and by mechanical means. The filter vessel is filled with the suspension under pressure and it passes through the filter bed, leaving the solids in the filter bed.

According to the invention, the terminology “contacting” is intended to mean that two or more components are being brought together either in solid and/or liquid/fluid form. In one aspect, “contacting is intended to mean that the acid treated feedstock is mixed with a filter aid and/or with an adsorbent. Consequently, e.g. the filter aid and/or the adsorbent may be in powder form or particulate form, or as a slurry, or as a solution.

### DETAILED DESCRIPTION OF THE INVENTION

As mentioned herein, the process according to the invention enables use of feedstocks or raw materials that are considered in the art to be less economically attractive or difficult to purify or refine for any further use.

Specifically, present invention relates to a process comprising the steps;
i) providing a feedstock,
ii) optionally heating the provided feedstock
iii) treating the provided feedstock with an acid, wherein the acid is capable of forming a precipitate, or salt, or chelate with e.g. metals and/or phospholipids as impurities present in the feedstock,
iv) treating the acid treated feedstock in iii) with process water, wherein the water content of the acid treated feedstock in iv) is in the range of from about 1 wt % to about 6 wt %, preferably from about 1.5 wt % to about 4 wt %, more preferably from about 2 wt % to about 3 wt %,
v) evaporating the water under vacuum from the acid treated feedstock in iv),
vi) optionally, recovering and recycling from step v) the evaporated water to at least partially re-use it as process water in step iv) and/or in step iii),
vii) contacting the chelated or precipitated metals and/or phospholipids from the acid treated feedstock, with a filter aid and/or adsorbent,
viii) removing the chelates or precipitates and filter aid and/or absorbent by filtration, with or without pre-coat, to obtain an acid treated filtered feedstock,
ix) bleaching the acid treated filtered feedstock from step vii), to thereby obtain an acid treated filtered bleached feedstock.

In yet a further aspect, present invention relates to a process for refining or purifying a feedstock, the process comprising the steps of;
i) providing a feedstock,
ii) heating the provided feedstock to 70-90° C.,
iii) treating the provided feedstock with an acid, wherein the acid is capable of forming a precipitate, or salt, or chelate with impurities, such as metals and/or phospholipids, present in the feedstock,
iv) treating the acid treated feedstock in iii) with process water wherein the water content of the acid treated feedstock in iv) is in the range of from about 1 wt % to about 6 wt %,
v) evaporating the water under vacuum from the acid treated feedstock in iv),
vi) optionally, recovering and recycling from step v) the evaporated water to at least partially re-use it as process water in step iv) and/or in step iii),
vii) contacting the chelated or precipitated metals and/or phospholipids from the acid treated feedstock, with a filter aid and/or an adsorbent such as e.g. silica hydrogel,
viii) removing the chelates or precipitates and the filter aid and/or adsorbent by filtration, with or without pre-coat, to obtain an acid treated filtered feedstock, and
ix) bleaching the acid treated filtered feedstock from step viii), to thereby obtain an acid treated filtered bleached feedstock.

In one aspect, present invention relates to a process comprising the steps of;
a) providing a feedstock,
b) treating the feedstock with an acid, wherein process water is added to the feedstock and acid mixture,
c) removing the added process water to obtain an acid treated feedstock,
d) recycling the removed process water and recycling said process water back into the process in step b)
e) mixing the obtained acid treated feedstock resulting from step c) with a filter aid and/or an adsorbent,
f) removing the filter aid and/or adsorbent by filtration, with or without pre-coat, to obtain an acid treated and filtered feedstock.

The process according to the invention may be followed by a bleaching step that may succeed step f).

According to one aspect, the acid treated feedstock is dried by removal of the process water illustrated herein and e.g. in step c) or e.g. step v). In a further aspect, the dried acid treated feedstock may be mixed or contacted with a filter aid and/or adsorbent.

In one aspect, the feedstock may in principle be of any type of origin. In one embodiment, the feedstock may comprise or consist of e.g. palm oil mill effluent (POME) oil, any type of brown grease (BG) such as e.g. gutter oil, trap grease, DAF (Dissolved Air Flotation) grease, sewage sludge and mixed grease trap waste streams, or any mixtures thereof.

In a specific embodiment, the feedstock may comprise or consist of POME oil.

In another aspect, the feedstock may comprise or consist of gutter oil.

In yet a further aspect, the feedstock may comprise or consist of trap grease.

According to the invention, the acid in the process may be any type of acid capable of forming a chelate, or a salt, or a complex, or any type of precipitate with one or more of the impurities present in the feedstock. Non-limiting examples may be e.g. citric acid, oxalic acid, malonic acid, succinic acid, glutaric acid, adipic acid, maleic acid, ethylenediaminetetraacetic acid (EDTA), phosphoric acid or the likes, or any mixtures thereof.

In a particular aspect, the acid may be e.g. citric acid.

The acid may be used neat, i.e. completely undiluted with any type of solvent or may be present in an aqueous solution. The concentration of the acid may be e.g. a concentration of about 5 wt % to about 100 wt %, such as e.g. 10 wt % to about 90 wt %, such as e.g. 20 wt % to about 80 wt %, such as e.g. 30 wt % to about 70 wt, such as e.g. 40 wt % to about 60 wt %, or such as e.g. 30 wt % to about 50 wt %.

If the concentration of the acid is too low, this may lead to low contact between cationic metals and H⁺ from the acid.

In a particular aspect, the acid concentration may be e.g. between about 30 wt % to about 50 wt %.

According to the invention, the provided feedstock may be heated prior to being contacted with the acid. The feedstock may be heated to a temperature in range of from about 50° C. to about 110° C., such as e.g. from about 60° C. to about 100° C., or such as e.g. about 70° C. to about 90° C. in step ii).

In a particular embodiment, the feedstock is heated to a temperature of e.g. about 70° C. to about 90° C. in step ii).

In another aspect, the feedstock may be heated to elevated temperatures prior to addition of the acid, and where after further heating may be obviated during contacting the feedstock with the acid in step iii). Thus, the contacting of the feedstock with the acid takes place at the same temperature as outlined in step ii).

In one aspect of the invention, the amount of acid is in excess of metal impurities present in the raw material or feedstock in i), such as e.g. the stoichiometric ratio of metals/acid is at least about 30%, such as at least about 40%, such as at least about 50% etc. In other words, the acid is present in an amount of at least 1:1 ratio (molar ratio or molar equivalents in relation to the impurities present in the feedstock), such as e.g. about 2:1, such as e.g. about 3:1, such as e.g. about 4:1, such as e.g. about 5:1 or more etc. Alternatively, the molar ratio or molar equivalent may be in any range of e.g. about 3:7 to about 9:1, such as e.g. about 2:3, or about 1:1, or about 3:2, or about 7:3, or about 4:1

The pH of the water phase of the feedstock/acid/water mixture may be in the range of about 1 to about 4, such as e.g. from about 2 to about 3 etc.

According to the invention, proper contact between the feedstock and acid is provided by any suitable technique. Non-limiting examples may be e.g. employing any type of mixing, stirring or agitation, which may be e.g. high shear mixing.

The reaction time between the acid and feedstock in step iii) may be at least about 5 minutes, such as e.g. about at least 10 minutes, such as e.g. about at least 15 minutes.

According to the invention, process water may be added to the process. In one aspect, process water may be added in step iv). The amount of added process water may be in any range of about 1 wt % to about 6 wt %, such as e.g. about 1.5 wt % to about 4 wt % or e.g. about 2 wt % to about 3 wt % based on the weight of the feedstock.

In one aspect, the process water may be added after completion of acid treatment step iii).

In a further aspect, the process water may be added as part of acid treatment step iii).

In yet a further aspect, the process water may be partly added as a part of acid treatment step iii) and the remaining part of process water may be added after completion of acid treatment step iii).

The treatment of the acid/feedstock mixture with process water in step iv), which may also be referred to as a hydration step, may take place by e.g. employing any type of mixing, stirring or agitation, which may be e.g. high shear mixing.

The process step iv) may have a duration of e.g. least 10 minutes or more, or at least 20 minutes or more, at least 30 minutes or more, or at least 45 minutes or more, such as e.g. about at least 60 minutes or more.

In a particular embodiment, the process step iv) may have a duration of e.g. at least about 45 minutes or more, such as e.g. about at least about 60 minutes or more.

According to the invention, after completion of the hydration step iv), the process may comprise a drying step, or a step comprising evaporation of the process water, or any type of combination of drying and evaporation. The purpose of this process step is to remove or reduce the amount of water in the feedstock.

The drying or evaporation step v), may be conducted under reduced pressure. The reduced pressure may be in range of about 70 mbar to about 100 mbar.

The temperature during step v) may be in range of e.g. about 70° C. to about 120° C., or such as e.g. about 80° C. to about 110° C., or such as e.g. 90° C. to about 110° C.

In a preferred embodiment, the temperature during step v) may be e.g. 90° C. to about 110° C.

The drying or evaporation step v) may also be conducted until such time that the amount of water after step v) is about 200 ppm to about 1200 ppm, such as e.g. about 400 ppm to about 700 ppm, such as e.g. about 500 ppm to about 600 ppm, such as e.g. about 700 ppm to about 1000 ppm based on the total weight of the dried feedstock resulting from step v).

In a particular aspect, the process water is recycled back into the process after collection of the evaporated process water in step v). In one aspect, at least about 60%, at least about 70%, at least about 80%, or at least about 90% of the evaporated water is recovered and recycled into the process, and consequently re-introduced into the process in step iv).

According to the invention, the process may comprise contacting the acid/feedstock mixture resulting from the drying step v) with a filter aid and/or an adsorbent. This operation aims at removing or at least partially eliminating the chelated or precipitated metals (as salts) and/or phospholipids or other impurities from the acid treated feedstock. This process step is illustrated in step vii).

The filter aid according to the invention may in principle be any filter aid known in the art. Thus, according to the invention, the filter aid may be any type of mineral based filter aid. Non-limiting examples may be e.g. diatomaceous earth, expanded perlite etc. In a particular embodiment, the filter aid may be e.g. diatomaceous earth, bleaching earth, silica gel or any combination thereof. The filter aid may be activated in any manner such as e.g. acid activated or surface activated by any suitable means. The filter aid may also be any type of plant based filter aid such as e.g. any type of cellulose based material as a filter aid. The filter aid may also be any type of polymer-based material such as e.g. a woven or non-woven material. The filter aid may also be any type of composite material. According to the invention, the filter aid may be any type of combination of a mineral based, plant based, polymer based or composite based filter aid.

The filter aid may be present in any suitable amount such as e.g. 0.1 wt % to about 2 wt %, such as e.g. about 0.5 wt % to about 1.0 wt %, such as e.g. about 0.5 wt % to about 0.6 wt %, such as e.g. about 0.3 wt % to about 0.5 wt %, or such as e.g. about 0.5 wt % to about 0.7 wt % in relation to the weight of the feedstock/acid mixture. It is to be noted that a combination of filter aids may be employed, such as e.g. but not limited to a mixture of diatomaceous earth and silica hydrogel.

The filter aid and/or the adsorbent may be mixed with the resulting feedstock mixture from step v) at elevated temperature such as e.g. about 80° C. to about 90° C.

The contacting time between the filter aid and/or the adsorbent, and the feedstock mixture may be for a period of time such as e.g. at least 10 minutes, or at least 20 minutes at least 30 minutes, or at least 45 minutes, such as e.g. about at least 60 minutes. In a particular aspect, the contacting time may be e.g. about 20 minutes. The contacting itself may comprise any type of mixing, stirring or agitation.

The filter aid and/or the adsorbent may be mixed with the resulting feedstock mixture from step v) at a pressure in any range of about 800 to about 1020 mbar.

According to the invention, after contacting the filter aid and/or the adsorbent (which may be e.g. but not limited to silica hydrogel or diatomaceous earth) with the feedstock mixture, a separation step ensues in order to remove the filter aid, the adsorbent as well as the impurities present in the feedstock. Such process step may be illustrated in step viii). The separation step may be executed by the aid of a pre-coated filter device. Alternatively, the separation step may be employed without a pre-coated filter device.

In one aspect according to the invention, in step vii) with respect to contacting the chelated or precipitated metals and/or phospholipids from the acid treated feedstock in step v), which may be by the aid of a filter aid and/or with an adsorbent. Consequently, in a further aspect of the invention, the filter aid may be employed alone, i.e. without being combined with an adsorbent. In a further aspect of the invention, the adsorbent may be employed alone, i.e. without being combined with a filter aid. Specifically, and in a non-limiting sense, trisyl alone may be employed for the purpose of the process according to the invention.

In yet another aspect, a combination of trisyl and diatomaceous earth (DE) may be employed for the purpose of the invention.

In another aspect, a combination of trisyl and bleaching earth (BE) may be employed for the purpose of the invention.

The pre-coating itself may be e.g. a filter aid, such as e.g. diatomaceous earth.

The removal step viii) may be performed at an elevated temperature such as e.g. in any temperature range of about 80° C. to about 100° C.

After the separation step viii), an acid treated filtered feedstock is obtained.

In one aspect of the invention, the process may comprise a bleaching step. Such step is illustrated as step ix) of the process. Thus, the bleaching step is executed on the acid treated filtered feedstock obtained from step viii).

The bleaching may comprise any known bleaching component or procedure known in the art. In one aspect, the bleaching comprises adding an acid such as e.g. citric acid. The bleaching may also comprise adding bleaching earth. In a particular embodiment, the bleaching step comprises first adding an acid after which a further bleaching agent is added, such as e.g. bleaching earth.

In addition to the many advantages of present invention, the loss of oil is below 0.7% wt compared to the typical oil loss in acid degumming, which is in the range of 3-10% wt. In one aspect, the oil loss is about 20% to about 70% in relation to weight of the filter aid, such as e.g. 30% to about 50% in relation to weight of the filter aid. Theoretical oil loss can be calculated using the following formula:

For instance, If 0.6% filter aid (FA) and 0.4% silica are used (Fresh silica contains 60% water. Spent silica contains 10% moisture), if cake contains 40% of oil

$$Oil loss = 6 kg FA / tn POME oil / ( 100 - 40 ) * 100 + 4 kg silica x 0.5 / tn POME oil / ( 100 - 40 ) * 100 - 6 kg FA / tn POME oil - 4 kg silica x 0.5 = 5.33 kg / tn = 0.53 \% POME oil loss$$

Present invention also relates to one or more products. The products may be obtainable by the process according to the invention.

In one aspect, the invention relates to an acid treated filtered and bleached POME oil obtainable by the process according to the invention, wherein the acid treated filtered and bleached POME oil may be characterised by having,
an amount of nitrogen containing compounds (N) of about 72.3 ppm or less,
phosphorus containing compounds (P) of about 2.7 ppm or less,
metals of about 4.6 ppm or less,
and further characterised by having a filtration resistance of about 328 GPas/kg² or less.

### EXAMPLES

The invention is further illustrated in the below seen non-limiting examples.

In the examples below, “N” refers to nitrogen containing compounds, “P” refers to phosphorous containing compounds. “CA” refers to citric acid. “BE” refers to bleaching earth. “DE” refers to diatomaceous earth. “Metals” refers to the amount of metal compounds present in the feedstock or resulting as salts/chelates/precipitates formed during the process of the invention. “POME” refers to palm oil mill effluent oil. “FA” refers to filter aid.

### Reference Bleaching Examples:

### Example 1

Crude POME 1 (N=44.0 ppm, P=37.5 ppm, metals=248.5 ppm) was bleached (CA=3000 ppm, added water=0%, BE=1%).

Bleached POME 1 N=21.7 ppm, P=1.7 ppm, metals=0.7 ppm, filtration resistance 1444 GPas/kg².

### Example 2

Crude POME 2 (N=189.3 ppm, P=19.5 ppm, metals=189.0 ppm) was bleached (CA=3000 ppm, added water=0%, BE=1%).

Bleached POME 2 N=86.0 ppm, P=7.6 ppm, metals=52.1 ppm, filtration resistance 1243 GPas/kg².

### Example 3

Crude POME 3 (N=97.3 ppm, P=24.8 ppm, metals=347.7 ppm) was bleached (CA=3000 ppm, added water=0%, BE=1%).

Bleached POME 3 N=52.2 ppm, P=2.6 ppm, metals=4.5 ppm, filtration resistance 2530 GPas/kg².

### Example 4

Crude POME 4 (N=105.2 ppm, P=23.1 ppm, metals=346.1 ppm) was bleached (CA=3000 ppm, added water=0%, BE=1%).

Bleached POME 4 N=59.6 ppm, P=3.1 ppm, metals=4.4 ppm, filtration resistance 3650 GPas/kg².

### Example 5

Trap grease (N=383 ppm, P=25 ppm, metals=810 ppm) was bleached (CA=1000 ppm, added water=0.4%, BE=1%). Bleached trap grease N=289 ppm, P=10.8 ppm, metals=465 ppm, filtration resistance 13076 GPas/kg².

### Example 6

Trap grease (N=383 ppm, P=25 ppm, metals=810 ppm) was bleached (CA=4000 ppm, added water=0.4%, BE=2%). Bleached trap grease N=233 ppm, P=8.2 ppm, metals=79.7 ppm, filtration resistance 30000 GPas/kg².

### Example 7

Gutter oil (N=173.4 ppm, P=27.3 ppm, metals=151.5 ppm) was bleached (CA=1000 ppm, added water=0.5%, BE=1%). Bleached gutter oil N=128 ppm, P=14.1 ppm, metals=82.9 ppm, filtration resistance 7378 GPas/kg².

### POME Acid Degumming+Bleaching Examples:

### Example 8

Crude POME 1 (N=44.0 ppm, P=37.5 ppm, metals=248.5 ppm) was acid degummed (CA=3000 ppm, added water=2.5%). Acid treated POME 1 was centrifuged to obtain acid treated centrifuged product (N=39.2, P=11.4, metals=6.5 ppm). Water/heavy phase resulted in pH=3 and COD (Chemical Oxygen Demand)=183000 mg/l.

Acid degummed product was further bleached (CA=500 ppm, added water=0.5%, BE=1%) to yield final acid degummed+bleached product (N=19.8 ppm, P=1.6 ppm, metals=4.5 ppm, filtration resistance 321 GPas/kg²).

### POME Acid Filtration+Bleaching Examples

### Example 9

Crude POME 1 (N=44.0 ppm, P=37.5 ppm, metals=248.5 ppm) was acid treated (CA=3000 ppm, added water=2.5%). Water was removed by evaporation and dried oil filter-aid (DE) filtered to obtain acid treated filtered product (N=37.2, P=10.7, metals=8.3 ppm, filtration resistance 180 GPas/kg²). Acid treated filtered product was further bleached (CA=500 ppm, added water=0.5%, BE=1%) to yield final acid treated filtered+bleached product (N=20.6 ppm, P=1.6 ppm, metals=0.8 ppm, filtration resistance 287 GPas/kg²).

### Example 10

Crude POME 2 (N=189.3 ppm, P=19.5 ppm, metals=189.1 ppm) was acid treated (CA=3000 ppm, added water=3.1%). Water was removed by evaporation and dried oil filter-aid (DE) filtered to obtain acid treated filtered product (N=125.0 ppm, P=4.3 ppm, metals=10.3 ppm, filtration resistance 270 GPas/kg²). Acid treated filtered product was further bleached (CA=500 ppm, added water=0.5%, BE=1%) to yield final acid treated filtered+bleached product (N=86.4 ppm, P=1.9 ppm, metals=4.7 ppm, filtration resistance 377 GPas/kg²).

### Example 11

Crude POME 3 (N=97.3, P=24.8, metals=347.7 ppm) was acid treated (CA=3000 ppm, added water=2.6%). Water was removed by evaporation and dried oil filter-aid (DE) filtered to obtain acid treated product (N=84.1, P=9.6, metals=5.9 ppm, filtration resistance 180 GPas/kg²). Acid treated filtered product was further bleached (CA=500 ppm, added water=0.5%, BE=1%) to yield final acid treated filtered+bleached product (N=58, P=2.4, metals=1.9 ppm, filtration resistance 359 GPas/kg²).

### Example 12

Crude POME 4 (N=105.2, P=23.1, metals=346.1 ppm) was acid treated (CA=3000 ppm, added water=1.9%). Water was removed by evaporation and dried oil filter-aid (DE) filtered to obtain acid treated filtered product (N=94.7, P=8.4, metals=8.3 ppm, filtration resistance 4 GPas/kg²). Acid treated filtered product was further bleached (CA=500 ppm, added water=0.5%, BE=1%) to yield final acid treated filtered+bleached product (N=70, P=2.3, metals=1.7 ppm, filtration resistance 311 GPas/kg²).

### Example 13

Same Crude POME 4 (N=105.2 ppm, P=23.1 ppm, metals=346.1 ppm) was acid treated (CA=1800 ppm, added water=2%). Water was removed by evaporation and dried oil mixed with filter-aid(DE)/trisyl at a ratio 0.4% trisyl/0.6 filter aid and filtered (Misc ID831) to obtain acid treated filtered product (N=96.6, P=5.5, metals=10.1 ppm, filtration resistance 259 GPas/kg²). Acid treated filtered product was further bleached (CA=500 ppm, added water=0.5%, BE=1%) to yield final acid treated+bleached product (N=68.6, P=1.9, metals=3.5 ppm, filtration resistance 301 GPas/kg²).

### Trap Grease and Gutter Oil Acid Filtration+Bleaching Examples

### Example 14

Trap grease (N=383 ppm, P=25 ppm, metals=810 ppm) was acid treated (CA=7500 ppm, added water=2.7%). Water was removed by evaporation and dried oil mixed with filter-aid (DE)/trisyl at a ratio 0.4% trisyl/0.6 filter aid and filtered to obtain acid treated filtered product (N=305, P=8.8, metals=19.9 ppm). Acid treated filtered product was further bleached (CA=1000 ppm, added water=0.8%, BE=1%) to yield final acid treated filtered+bleached product (N=239, P=5.9, metals=9.4 ppm, filtration resistance 387 GPas/kg²).

### Example 15

Gutter oil (N=173.4 ppm, P=27.3 ppm, metals=151.5 ppm) was acid treated (CA=1080 ppm, added water=3.0%). Water was removed by evaporation and dried oil mixed with filter-aid/trisyl at a ratio 0.4% trisyl/0.6 filter aid (DE) and filtered to obtain acid treated filtered product (N=155, P=10.4, metals=44.7 ppm). Acid treated filtered product was further bleached (CA=1000 ppm, added water=0.5%, BE=1%) to yield final acid treated filtered+bleached product (N=113, P=5.5, metals=3.7 ppm, filtration resistance 931 GPas/kg²).

The POME oil results of the examples above are summarised in the below tables.

TABLE 1

| | | | | | Acid |
|---|---|---|---|---|---|
| | | | | | filtration |
| | | | Reference | | CA 3000 |
| | | Crude | Bleaching | Acid | ppm 1% |
| | | POME | CA | degumming + | filter aid + |
| | | 1 | 3000 ppm | bleaching | bleaching |
| Nitrogen | mg/kg | 44.0 | 21.7 | 19.8 | 20.7 |
| Silicon | mg/kg | 5.6 | 0.3 | 0.4 | 0.2 |
| Phosphorous | mg/kg | 37.5 | 1.7 | 1.7 | 1.7 |
| Total metals | mg/kg | 248.5 | 0.7 | 4.6 | 0.8 |
| Filterability | GPas | | 1,444 | 321 | 287 |
| resistance for | kg⁻² | | | | |
| (140-150 g) | | | | | |
| Filtration | min | | 20 | 6.0 | 7.0 |
| time | | | | | |
| Average flux | kg | | 419 | 1,281 | 1,248 |
| | m⁻² h⁻¹ | | | | |

TABLE 2

| | | | | | Acid |
|---|---|---|---|---|---|
| | | | | | filtration |
| | | | Reference | | CA 3000 |
| | | Crude | Bleaching | Acid | ppm, 1% |
| | | POME | CA | degumming + | FA + |
| | | 2 | 3000 ppm | bleaching | bleaching |
| Nitrogen | mg/kg | 189.3 | 86.0 | 83.9 | 86.4 |
| Silicon | mg/kg | 31.0 | 0.4 | 0.8 | 0.4 |
| Phosphorous | mg/kg | 19.5 | 7.6 | 1.7 | 2.0 |
| Total metals | mg/kg | 189.0 | 52.1 | 5.3 | 4.7 |
| Filterability | GPas | | 1,243 | 760 | 377 |
| resistance for | kg⁻² | | | | |
| (140-150 g) | | | | | |
| Filtration | min | | 16 | 10 | 6.5 |
| time | | | | | |
| Average flux | kg | | 499 | 854 | 1307 |
| | m⁻² h⁻¹ | | | | |

TABLE 3

| | | | | | Acid |
|---|---|---|---|---|---|
| | | | | | filtration |
| | | | | | CA 3000 |
| | | | Reference | | ppm, |
| | | Crude | Bleaching | Acid | 1.0% |
| | | POME | CA | degumming + | filter aid + |
| | | 3 | 3000 ppm | bleaching | bleaching |
| Nitrogen | mg/kg | 97.3 | 52.2 | 59.5 | 58.0 |
| Silicon | mg/kg | 78.5 | 0.3 | 0.4 | 0.4 |
| Phosphorous | mg/kg | 24.8 | 2.6 | 2.4 | 2.4 |
| Total metals | mg/kg | 347.7 | 4.5 | 3.0 | 1.9 |
| Filterability | GPas | | 2530 | 368 | 359 |
| resistance for | kg⁻² | | | | |
| (140-150 g) | | | | | |
| Filtration | min | | 27 | 6.5 | 6.5 |
| time | | | | | |
| Average flux | kg | | 296 | 1279 | 1259 |
| | m⁻² h⁻¹ | | | | |

TABLE 4

| | | | | | Acid filtration | |
|---|---|---|---|---|---|---|
| | | | Reference | | CA 1800 ppm, | Acid filtration |
| | | | Bleaching | Acid | 0.6% filter | CA 3000 ppm, |
| | | Crude | CA 3000 | degumming + | aid + 0.4% | 1.0% filter |
| | | POME 4 | ppm | bleaching | trisyl + bleaching | aid + bleaching |
| Nitrogen | mg/kg | 105.2 | 59.6 | 68.0 | 68.58 | 70.00 |
| Silicon | mg/kg | 68.1 | 0.37 | 0.43 | 0.46 | 0.40 |
| Phosphorous | mg/kg | 23.1 | 3.1 | 2.29 | 1.99 | 2.33 |
| Total metals | mg/kg | 346.1 | 4.4 | 3.06 | 3.57 | 1.70 |
| Filterability resistance for | GPas kg⁻² | | 3650 | 537 | 301 | 311 |
| (140-150 g) | | | | | | |
| Filtration time | min | | 31 | 7.5 | 6 | 7.5 |
| Average flux | kg m⁻² h⁻¹ | | 245 | 1005 | 1350 | 1054 |

In reference bleaching all four POME samples were treated with 3000 ppm citric acid and 1 wt % bleaching earth without adding water.

In acid degumming four POME samples were treated with 3000 ppm citric acid and 2.5 wt % added water after which the samples were treated with 500 ppm citric acid, 1 wt % bleaching earth and 0.5 wt % added water.

In acid filtration four POME samples were treated with 3000 ppm citric acid and 2.5 wt % added water, followed by evaporation of water and filter aid filtration 1 wt % filter aid, one POME sample was treated with 1800 ppm citric acid and 2.5 wt % added water, followed by evaporation of water and 0.6% filter aid and 0.4% adsorbent (trisyl), after which the samples were treated with 500 ppm citric acid 1 wt % bleaching earth and 0.5 wt % added water.

With all POME samples removal of nitrogen, silicon, phosphorous and metals were on the same level or better with acid filtration followed by bleaching compared to reference bleaching while filtration times were significantly decreased.

In table 4, the removal rates for nitrogen, silicon, phosphorous and metals crude POME sample 4 after acid filtrations followed by bleaching are on the same level with reference bleaching but the filterability resistance values after acid filtrations are significantly lower 301-311 GPas kg⁻² vs. 3650 GPas kg⁻².

The best result is achieved with the method described in example 12 where crude POME 4 was first treated with a lower acid amount (CA=1800 ppm), added water=2 wt %). Water was removed by evaporation and dried oil mixed with filter-aid(DE)/adsorbent (trisyl) at a ratio 0.6 filter aid (DE)/0.4% adsorbent (trisyl) and filtered to obtain acid treated filtered product (N=96.6, P=5.5, metals=10.1 ppm, filtration resistance 259 GPas/kg²). Acid treated filtered product was further bleached (CA=500 ppm, added water=0.5%, BE=1%) to yield final acid treated+bleached product (N=68.6, P=1.9, metals=3.5 ppm, filtration resistance 301 GPas/kg²). It can be seen that method in example 12 removed more metals than reference bleaching even using less citric acid and P removal was higher compared when using only filter aid, showing key role of adsorbent (trisyl) in reducing the residual P in POME oil, moreover the filtration resistance was the lowest value, resulting to over 80% decrease in filtration time, from 31 to 6 minutes.

Tables 1-4 show that acid degumming followed by bleaching and acid filtration followed by bleaching, that use the same amount of added water and the same amount of bleaching earth, are equally effective for removing nitrogen, silicon and phosphorous. However, acid filtration followed by bleaching is more effective in removing metals.

As can be seen from table 1 to 4, the purification results after acid filtrations are on the same level, even better depending on the impurity and acid filtration conditions, with reference bleaching but the filterability resistance after acid filtrations is significantly lower 301-311 GPas kg⁻² vs. 3650 GPas kg⁻², which in the best case resulted to over 80% decrease in filtration time, from 31 to 6 minutes.

Adjusted amount of citric acid during acid treatment and the combined use of filter aid and adsorbent (silica hydrogel trisyl) in acid filtration allows to minimise the residual content of P and metals in POME oil.

### Re-Cycling of Process Water

### Example 16

Acid treated (CA 1800 ppm and H₂O 2%) POME 4 was centrifuged, obtaining a centrifuged product (N=109.2 ppm, P=9.1 ppm, metals=9.0 ppm).

Water/heavy phase from centrifugation pH=3.0.

The evaporated water from Example 10 was collected and used as process water for the same crude POME 4 (N=105.2, P=23.1, metals=346.1 ppm) acid filtration using same conditions (with CA 1800 ppm and H₂O 2% as reused water collected from Example 9) obtaining a centrifuged product (N=107.5 ppm, P=9.2 ppm, metals=16.9 ppm). Heavy/water phase pH=3.6.

Using recycled process water from water evaporation before filter aid/silica hydrogel step had the same P removal than using fresh process water, metals content slightly increased and pH from centrifuged water was in the same order of magnitude, showing that impurities removal using recycled water from water evaporation in acid filtration is as effective as using fresh process water, and water phase pH remains in the same order of magnitude.

1-23. (canceled)

24. A process for refining or purifying a feedstock, wherein the process comprises:
i) providing a feedstock;
ii) optionally heating the provided feedstock;
iii) treating the provided feedstock with an acid, wherein the acid is capable of forming a precipitate, or a salt, or a chelate with impurities, and/or with metals and/or phospholipids, present in the feedstock, thereby obtaining an acid treated feedstock;
iv) treating the acid treated feedstock in iii) with a process water;
v) evaporating water from the acid treated feedstock in iv);
vi) recovering and recycling from step v) the evaporated water to at least partially re-use it as process water in step iv) and/or in step iii);
vii) contacting chelated or precipitated impurities, metals and/or phospholipids from the acid treated feedstock in step v), with a filter aid and/or with an adsorbent;
viii) removing chelates or precipitates and the filter aid and/or the adsorbent by filtration, with or without pre-coat, to obtain an acid treated filtered feedstock; and
ix) bleaching the acid treated filtered feedstock from step viii.

25. The process according to claim 24, wherein feedstock comprises:
at least one or more of palm oil mill effluent (POME) oil, brown grease, gutter oil, trap grease, DAF (dissolved air flotation) grease, sewage sludge, and/or mixed grease trap waste streams.

26. The process according to claim 24, comprising:
heating the feedstock to a temperature in a range of from about 50° C. to about 110° C., and/or from about 60° C. to about 100° C., and/or about 70° C. to about 90° C. in step i) prior to adding of the acid in step iii).

27. The process according to claim 24, wherein the acid treatment of the feedstock in step iii) is performed at a select temperature.

28. The process according to claim 24, wherein the acid is at least one or more of citric acid, oxalic acid, malonic acid, succinic acid, glutaric acid, adipic acid, maleic acid, ethylenediaminetetraacetic acid (EDTA), phosphoric acid or the likes, and/or any mixtures thereof.

29. The process according to claim 1, wherein the acid is a citric acid solution in an aqueous solution of a concentration of about 20 wt % to about 60 wt %, and/or 30 wt % to about 50 wt %.

30. The process according to claim 24, wherein an amount of acid to amount of metal impurities present in the feedstock in i), is in any range of a ratio of about 3:7 to about 9:1, and/or about 2:3, and/or about 1:1, and/or about 3:2, about 7:3, and/or about 4:1.

31. The process according claim 24, wherein the acid treatment in step iii) comprises:
providing proper contact between the feedstock and the acid and/or employing any type of mixing, stirring, agitation, and/or high shear mixing.

32. The process according to claim 24, wherein a reaction time in step iii) is at least about 5 minutes, and/or about at least 10 minutes, and/or about at least 15 minutes.

33. The process according to claim 24, wherein the pH in step iii) is in a range of about 1 to about 4, and/or from about 2 to about 3.

34. The process according to claim 32, comprising:
adding water to the process after the acid is added and after the reaction time, and/or partially together with the addition of acid to the feedstock in step iii).

35. The process according to claim 24, wherein a water content of the acid treated feedstock in step iv) is adjusted to be in a range of from about 1 wt % to about 6 wt %, and/or from about 1.5 wt % to about 4 wt %, and/or from about 2 wt % to about 3 wt %, in relation to a total weight of the feedstock.

36. The process according to claim 24, wherein the added process water in step iv) is contacted with the feedstock mixture by employing any type of mixing, stirring, agitation, and/or high shear mixing.

37. The process according to claim 24, wherein the hydration time in step iv) is at least 10 minutes, and/or at least 20 minutes at least 30 minutes, and/or at least 45 minutes, and/or about at least 60 minutes.

38. The process according to claim 24, wherein the drying step/evaporation step v) is performed under vacuum, in range of about 70 mbar to about 100 mbar, and at temperature ranges of about 70° C. to about 120° C., and/or about 80° C. to about 110° C.

39. The process according to claim 24, wherein at least about 60%, and/or at least about 70%, and/or at least about 80%, and/or at least about 90% of the evaporated water is recovered and recycled into the process.

40. The process according to claim 24, wherein a remaining amount of water after step v) is about 200 ppm to about 1200 ppm, and/or about 400 ppm to about 700 ppm, and/or about 500 ppm to about 600 ppm, and/or about 700 ppm to about 1000 ppm based on a total weight of the dried feedstock.

41. The process according to claim 24, wherein the filter aid is a mineral based filter aid and/or silica based or based on diatomaceous earth, a plant based filter aid such and/or cellulose based, a polymer based filter aid, and/or any type of composite based filter aid.

42. The process according to claim 24, wherein the adsorbent is activated carbon, silica based compounds and/or silica gel of various types and morphology and/or silica hydrogel and/or a mixture thereof.

43. The process according to claim 24, comprising:
mixing the dried and acid treated feedstock with a filter aid and/or an adsorbent in step vii), wherein the filter aid is diatomaceous earth as bodyfeed (0.5-1.0 wt-%) and/or silica gel as bodyfeed (0.5-0.6 wt-% as silica gel, and/or as blend with a proportion of 0.3-0.5 wt-% as silica gel and 0.7-0.5 wt-% as filter aid) at an elevated temperature of about 80° C. to about 90° C. and agitated for a period of about 20 min at 800-1020 mbar a pressure.

44. The process according to claim 24, comprising:
contacting the chelated or precipitated metals and/or phospholipids from the acid treated feedstock in v), with a filter aid and/or with an adsorbent, wherein the adsorbent is a silica hydrogel.

45. The process according to claim 1, comprising:
executing the removal/separation in step viii) by filtration by employing a pre-coated filter device, at elevated temperature of about 80° C. to about 90° C.

46. The process according to claim 24, wherein the bleaching in step ix) comprises:
adding a citric acid solution after which bleaching earth is added to the mixture.
